(19) United States
(12) Patent Application Publication
(10) Pub. No.: US 2013/0061697 A1
(43) Pub. Date: Mar. 14, 2013

(54) APPARATUS FOR CONTAINED INSPECTION AND TRANSPORTATION OF SUSPECT OBJECTS

(71) Applicant: Timothy Roberts, Phillip (AU)

(72) Inventor: Timothy Roberts, Phillip (AU)

(21) Appl. No.: 13/530,574

(22) Filed: Jun. 22, 2012

Related U.S. Application Data
(63) Continuation of application No. 13/073,164, filed on Mar. 28, 2011, now abandoned.
Application No. 13/073,164 is a continuation of application No. 10/538,550, filed on Jan. 23, 2006, now abandoned.

(30) Foreign Application Priority Data
Dec. 12, 2002 (AU) 2002953296

(51) Int. Cl. G01D 11/24

(52) U.S. Cl. 73/865.8

(57) ABSTRACT

Apparatus/device for the contained inspection and possible transportation of a potentially dangerous object, the apparatus including: an inspection unit (10), the inspection unit (10) able to open to receive the object and then close to provide a sealed environment for manual inspection of the object, the inspection unit (10) also including at least one glove member allowing a user external to the sealed environment of the closed inspection unit (10) to manipulate the object within the closed inspection unit (10); and, a transportation unit (80) adapted to wholly receive the inspection unit (10) and provide a further sealed environment containing the inspection unit (10) containing the object; whereby, the combination of the inspection unit (10) and the transportation unit (80) safely contain the object for possible transportation.

### TECHNICAL FIELD

The present invention relates to an apparatus or device for the contained inspection and transportation of objects suspected of being potentially dangerous, and in particular, to an apparatus for the contained inspection and possible subsequent transportation of envelopes, mail, packages, parcels, letters and the like, suspected of containing potentially dangerous substances.

### BACKGROUND ART

Subsequent to the terrorist activity of 11 Sep. 2001 in the United States and the subsequent anthrax contaminated envelopes entering the mail system in the United States, many other countries have also experienced a spate of envelopes being received via the mail system which contain suspicious white powder.

Prior to being able to determine whether or not the white powder is a dangerous substance a response procedure is required to be initiated for safety reasons. The response procedure requires a full hazardous material handling procedure to be initiated by relevant emergency response authorities. The affected area, including all affected persons, are generally required to be contained until such time as the results of the analysis of the unknown substance becomes available. Such incidents result in stress and trauma to the affected persons, considerable loss of productivity and ties up emergency service resources.

Given that it is relatively simple for an antagonist to insert a substance into an envelope, or any other similar package, which is often a harmless white powder, there is a need to provide a response procedure utilising apparatus that lessens the impact on affected persons, productivity and emergency services.

Laboratory “glove-box” type products are known that allow a user to insert his or her forearms and hands into gloves, allowing the user to safely handle objects within the glove-box. Such laboratory glove-boxes are bulky and are not designed to be transportable. Furthermore, they are typically also relatively expensive. Other styles of glove-boxes are constructed of plastic sheeting and require frames and inert gases to inflate them, which further complicates the procedure for safe handling of potentially dangerous objects. In addition, presently known glove-boxes are not robust and portable which is a significant disadvantage.

This identifies a need for apparatus for the contained inspection and possible transportation of potentially dangerous objects which overcomes or at least ameliorates the problems inherent in the prior art.

### DISCLOSURE OF INVENTION

The present invention provides an examination, isolation and transportation apparatus/device for suspicious objects, for example, suspicious mail that may potentially contain or be contaminated by dangerous biological or chemical agents. The apparatus/device is preferably relatively lightweight, robust, easy to use and readily transportable. The apparatus/device can find application in, for example but not limited to, a mail room environment, home, office, law enforcement agency, government department, military, vessel at sea, etcetera.

In a broad form the present invention provides apparatus for the contained inspection and possible transportation of a potentially dangerous object, the apparatus including:

an inspection unit, the inspection unit able to open to receive the object and then close to provide a sealed environment for manual inspection of the object, the inspection unit also including at least one glove member allowing a user external to the sealed environment of the closed inspection unit to manipulate the object within the closed inspection unit; and,

a transportation unit adapted to wholly receive the inspection unit and provide a further sealed environment containing the inspection unit;

whereby, the combination of the inspection unit and the transportation unit safely contain the object for possible transportation.

Preferably, at least a portion of the inspection unit is substantially transparent. Also preferably, at least a portion of a body section or a base section of the inspection unit is opaque, preferably of a dark colour. In a particular use, the object is an envelope, mail, package, parcel, letter or the like.

According to one aspect of an embodiment of the invention, the inspection unit includes a first section and a second section adapted to be clamped or latched together. According to another aspect of an embodiment of the invention, the first section and the second section are hinged together. According to still another aspect of an embodiment of the invention, the first section is a lid section and the second section is a body section or a base section.

Preferably, the sealed environments of the inspection unit and the transportation unit are substantially airtight. Also preferably, the user can visually inspect the object in the inspection unit.

In a specific embodiment of the present invention, two glove members are provided. In a further specific embodiment of the present invention, the transportation unit includes a first section and a second section adapted to be clamped together. In still a further specific embodiment of the present invention, the first section and the second section of the transportation unit are hinged together. In still a further specific embodiment of the present invention, the first section is a lid section and the second section is a body section or a base section. In an alternate embodiment, the transportation unit includes a lid section and a body section or base section adapted to be press-sealed together.

Preferably, the transportation unit is resilient against external forces and shocks. In still a further specific embodiment of the present invention, the inspection unit also includes integrated magnifying means. In still a further specific embodiment of the present invention, the transportation unit includes padding or shock absorbing material. In still a further specific embodiment of the present invention, closure of the transportation unit securely holds the inspection unit placed therein.

In a further broad form the present invention provides a device for the contained inspection and safe transportation for further examination, if required, of received mail, the device comprising:

an inspection unit adapted to provide a sealed environment, the inspection unit allowing a user to visually inspect received mail placed in the inspection unit, the inspection unit also including one or more glove members allowing the user to manipulate the mail within the inspection unit; and,

a transportation unit adapted to wholly receive the inspection unit after user inspection of the mail and to provide a further sealed environment and physical protection for the inspection unit during transportation. According to a particular aspect of this form of the invention, the inspection unit and the transportation unit are each formed of substantially two distinct sections and additionally provided with one or more clamps to seal the units.

### BRIEF DESCRIPTION OF THE FIGURES

The present invention should become apparent from the following description, which is given by way of example only, of a preferred but non-limiting embodiment thereof, described in connection with the accompanying figures.

FIG. 1 illustrates an embodiment of the present invention, wherein the figure shows a front perspective view of the inspection unit.

FIG. 2 illustrates an embodiment of the present invention, wherein the figure shows a rear perspective view of the inspection unit.

FIG. 3 illustrates a top view of the inspection unit illustrated in FIG. 1 when closed.

FIG. 4 illustrates a side view of the inspection unit illustrated in FIG. 1 when closed.

FIG. 5 illustrates a front perspective view of the inspection unit illustrated in FIG. 1 when closed.

FIG. 6 illustrates a rear perspective view of the inspection unit illustrated in FIG. 1 when closed.

FIG. 7 illustrates a front view of the inspection unit illustrated in FIG. 1 when closed.

FIG. 8 illustrates an embodiment of the present invention, wherein the figure shows an exploded perspective view of the transportation unit.

FIG. 9 illustrates an embodiment of the present invention, wherein the figure shows a perspective view of the transportation unit when closed.

FIG. 10 illustrates a top view of the transportation unit illustrated in FIG. 9.

FIG. 11 illustrates a cross-sectional view along line B-B of the transportation unit illustrated in FIGS. 9 and 10.

FIG. 12 illustrates a side view of the transportation unit illustrated in FIG. 9.

FIG. 13 illustrates a cross-sectional view along line A-A of the transportation unit illustrated in FIGS. 9 and 12.

FIG. 14 illustrates an alternate further side view of the transportation unit illustrated in FIG. 9.

### MODES FOR CARRYING OUT THE INVENTION

The following modes are described in order to provide a more precise understanding of the subject matter of the present invention and should not be considered as limiting the scope of the present invention. In the figures, incorporated to illustrate the features of the present invention, like reference numerals are used to identify like parts throughout the figures.

In a preferred embodiment apparatus is provided which allows a user to examine suspicious mail or the like in an airtight or sealed environment, whereby the mail and its contents can be visually examined within the airtight environment. If further analysis of the mail and/or its contents is required the mail can be maintained in the airtight environment and transferred to a second airtight or sealed environment which provides important additional protection during transportation to a specialist analysis site, for example a biochemical or forensic laboratory.

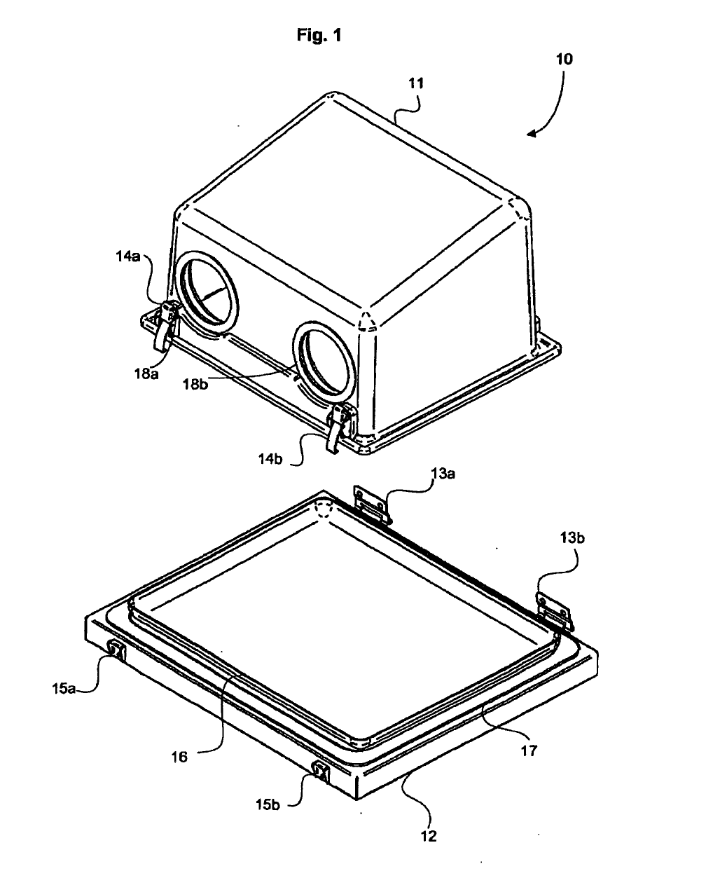

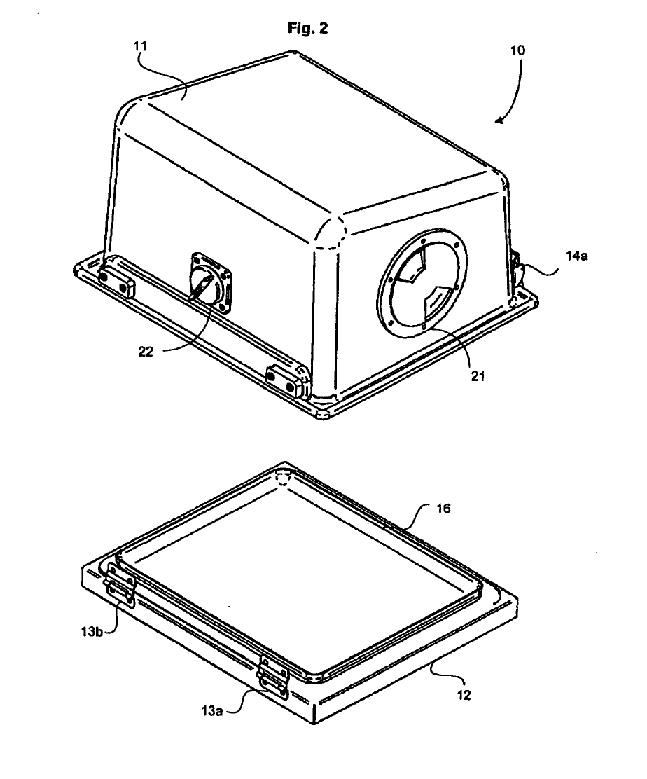

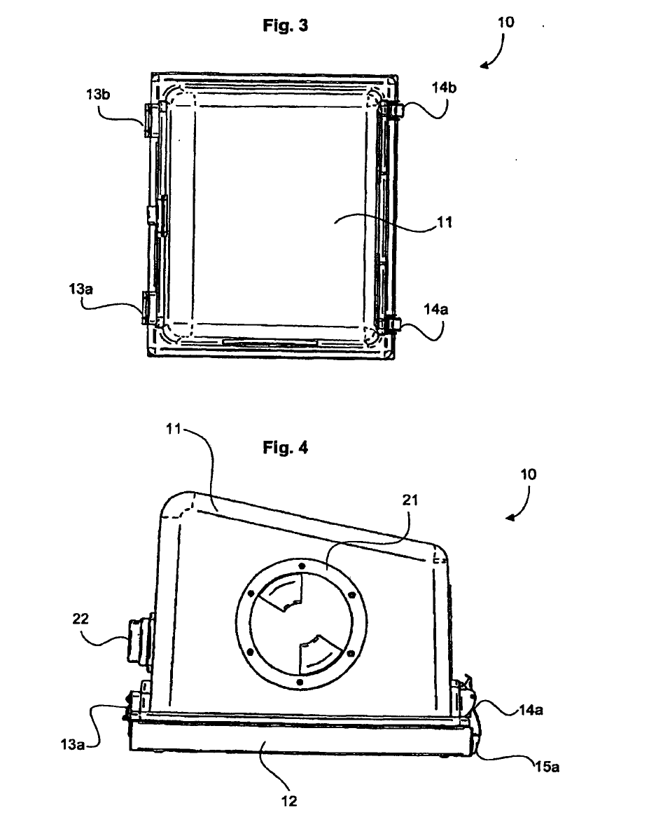

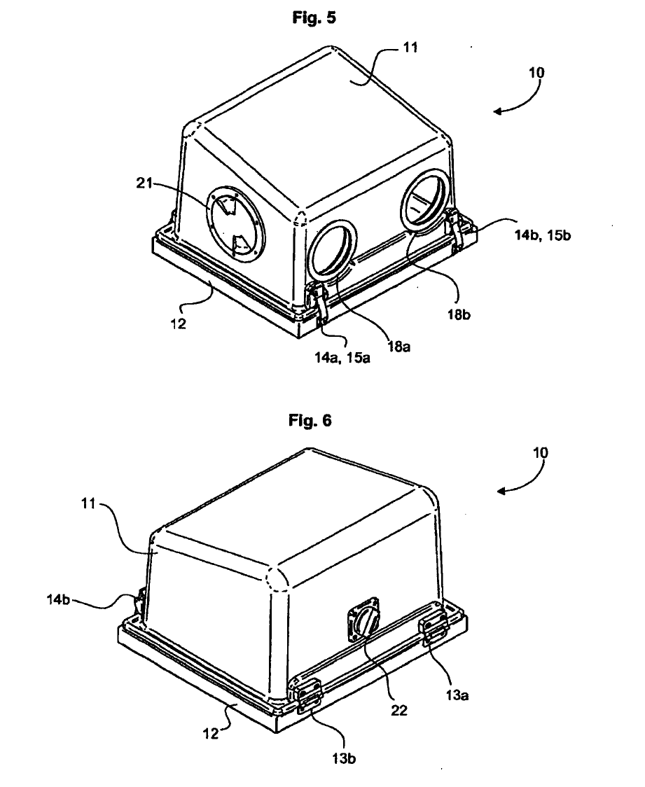

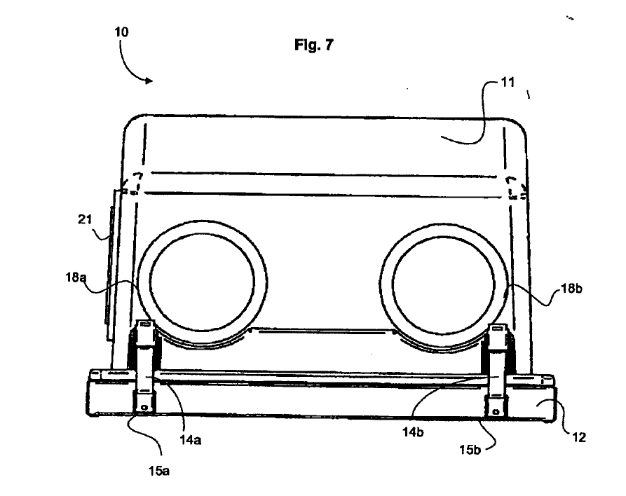

Referring to FIGS. 1 to 7, when a potentially dangerous object (not illustrated) is received and identified as being potentially dangerous, the object is placed in the inspection unit 10. To place the object in the inspection unit 10 the lid section 11 is removed or opened and the object placed in or on the base section (or alternatively body section) 12 of the inspection unit 10. The lid section 11 is then sealed against the base section 12 to provide a sealed environment containing the object. The extent of the height of the lid section 11 or the base section 12 can be varied. For example, the shapes of the lid section 11 and the base section 12 may be substantially interchanged so that the base section 12 can be considered as a body section having a substantial height. Alternatively, the lid section 11 and the body or base section 12 could be provided to be similar depths.

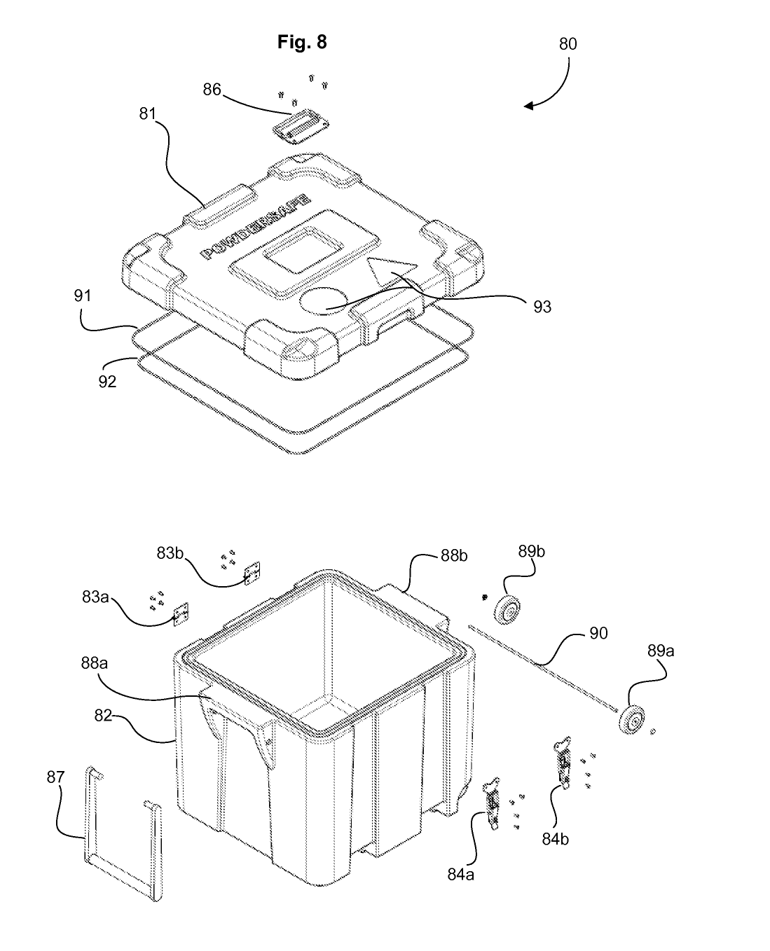

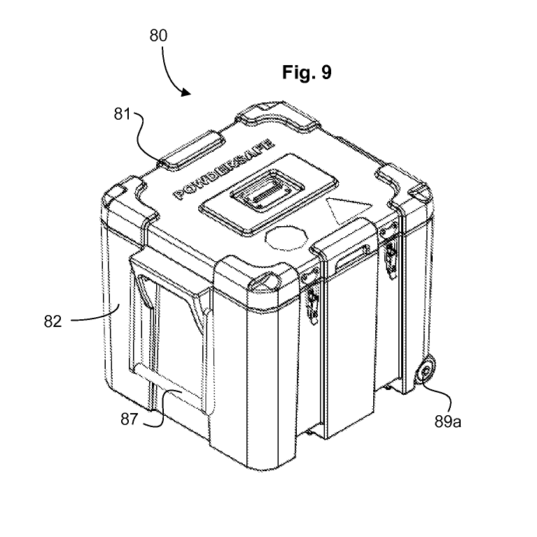

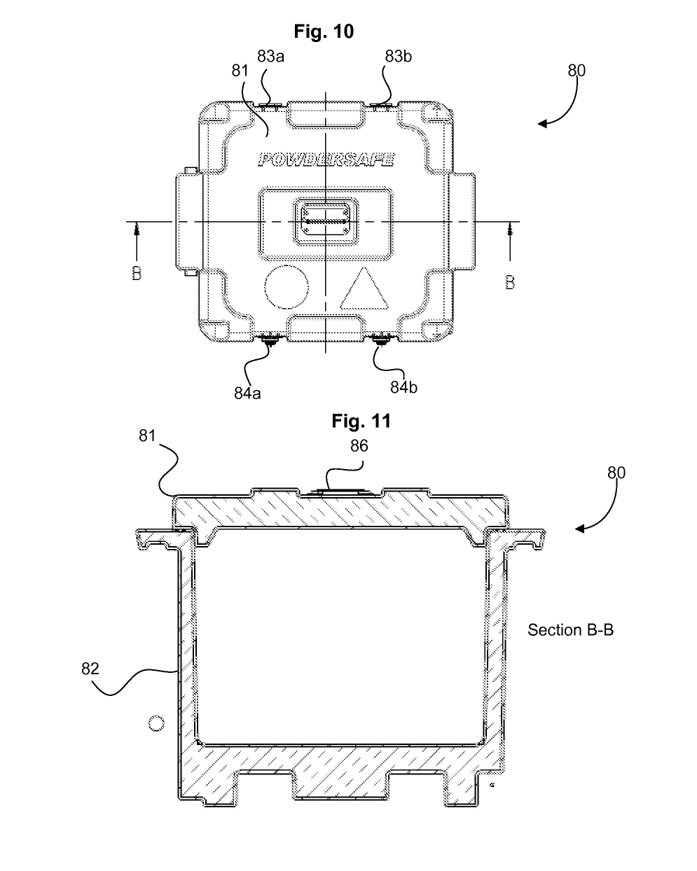

After examination of the object within the inspection unit 10, should the user believe that further analysis of the object or its contents is required, the inspection unit 10 is then wholly placed within a transportation unit (illustrated in FIG. 8). The inspection unit 10 is placed into a body section of the transportation unit after which a lid section of the transportation unit is sealed to the body section, thereby providing a further sealed environment that completely contains the inspection unit 10.

The potentially dangerous object is hence contained within two separate sealed environments and can then be relatively safely transported to an analysis site. Both the inspection unit and the transportation unit are preferably of a suitable size and material so that they are portable allowing ease of transportation of the potentially dangerous object to the analysis site.

Referring further to FIGS. 1 to 7 wherein various views and features of the inspection unit 10 are illustrated, the lid section 11 is preferably provided as an enclosure assembly that is substantially transparent allowing the user to visually inspect the potentially dangerous object. Parts of the lid section 11 may be opaque or the lid section 11 may be substantially totally manufactured from a transparent material, for example a transparent plastic. Regions of the base section 12 may also be transparent, but preferably, the base section 12 is substantially opaque, preferably of a dark colour such as black or dark blue. This assists the user in visually identifying a white powder against a dark background. Regions of the lid section 11 may similarly be a dark colour if desired. Preferably, the inspection unit 10 is substantially made of a moulded plastic(s).

The lid section 11 and the base section 12 are adapted to be clamped or closed together using clamp or latch means. In the preferred embodiment, two cranked hinges 13a and 13b are attached to the base section 12 and the lid section 11 to allow these sections to be joined together but rotatable with respect to each other. Draw latches 14a and 14b are also provided on the lid section 11 and associate with keepers or protrusions 15a and 15b, respectively, that are provided as part of, or attached to, the base section 12. When the lid section 11 is rotated to close against the base section 12 the latches 14a and 14b can be closed against the keepers 15a and 15b to seal the inspection unit 10. It should be noted that a varying number or variety of latch or clamp means can be utilised as required. For example, latches or clamps can be provided at different locations on the inspection unit and hinges 13a and 13b could be replaced with further clamps or latches. The clamp or latch means may be any type of device, or mixture of devices, which assist to secure or attach the lid section 11 to the base section 12 to provide a sealed environment internal to the inspection unit 10.

A tray 16 is also preferably provided on or integrated with the base section 12. The tray 16 may be fixed or removable. A seal or base gasket 17 is preferably provided associated with the base section 12, and a further seal or lid gasket (not illustrated) is preferably provided associated with the lid section 11. These seals or gaskets are provided at or near the interface between the lid section 11 and the base section 12 and abut each other when the inspection unit 10 is closed to assist in providing an air tight environment within the inspection unit 10. Alternatively, a single seal or gasket only might be provided associated with either the lid section 11 or the base section 12.

When the inspection unit 10 is closed the user then inserts both forearms/hands through the hand access orifices 18a and 18b so that glove members (not illustrated) attached to the hand access orifices 18a and 18b and internal to the inspection unit 10 are fitted over the users hands. The user is then able to use his or her hands to manipulate the object within the sealed environment of the inspection unit 10 without breaching the sealed environment.

The lid section 11 can also be provided with a magnifying section on the top surface so that when the user visually inspects the object within the inspection unit 10 the contents of the inspection unit 10 are magnified to the eyes of the user.

The inspection unit 10 can also be provided with an inspection port assembly 21 which can be sealed but provides the possibility to be used as a further access point to manipulate an object within the inspection unit 10. Preferably, glove members (not illustrated) are attached to access regions 18a and 18b, and possibly 21, however, it should be noted that any other type of device which allows a user to inspect and/or manipulate the object within the inspection unit 10, without breaching the sealed environment, could be utilised. Furthermore, a plug assembly or port 22 can be provided as illustrated. The plug assembly 22 could be utilised for a variety of purposes. In a particular embodiment, the port 22 is approximately 40 mm in diameter and allows fire and testing authorities a small port through which chemical or radiological probes can sample the contents of the unit 10, without having to open the main seal. The unit has been tested for compatibility with equipment such as the AP2C, PID (Photo Ionisation Detectors), the Bruker raid for chemicals, the Exploranium GR135 and Rotem 8200 for radiological substances. The unit may be taken to a controlled area where the rear port can be opened and testing performed. The plug 22 is then replaced, and if required, the outside of the unit 10 flushed down to remove any possible escaped contaminant. Use of decontamination foam or solutions is also possible. The larger port 21 is preferably just over 100 mm in diameter and is provided so that when the unit 10 is in a Biosafety cabinet access can be gained via port 21 instead of opening the main seal. Port 21 is large enough for a gloved hand or small equipment to be passed into the unit 10, again to reduce the exposure risk to the operator. Other uses of port 22 are also possible, for example, to equalise air pressure to facilitate opening of the inspection unit 10, to be attached to tubing or the like so that air may be removed from the inspection unit 10, for example to create a vacuum, to introduce a suitable gas into the inspection unit 10, or as a general purpose point of further access. It should be noted that both the inspection port assembly 21 and the plug or port assembly 22 need not necessarily be provided or can be provided in alternate locations or configurations. It should also be appreciated that if the lid section 11 is substantially planar and the base section 12 is provided with most of the height of the inspection unit 10, then the access orifices 18a and 18b would obviously be provided as part of the base section 12.

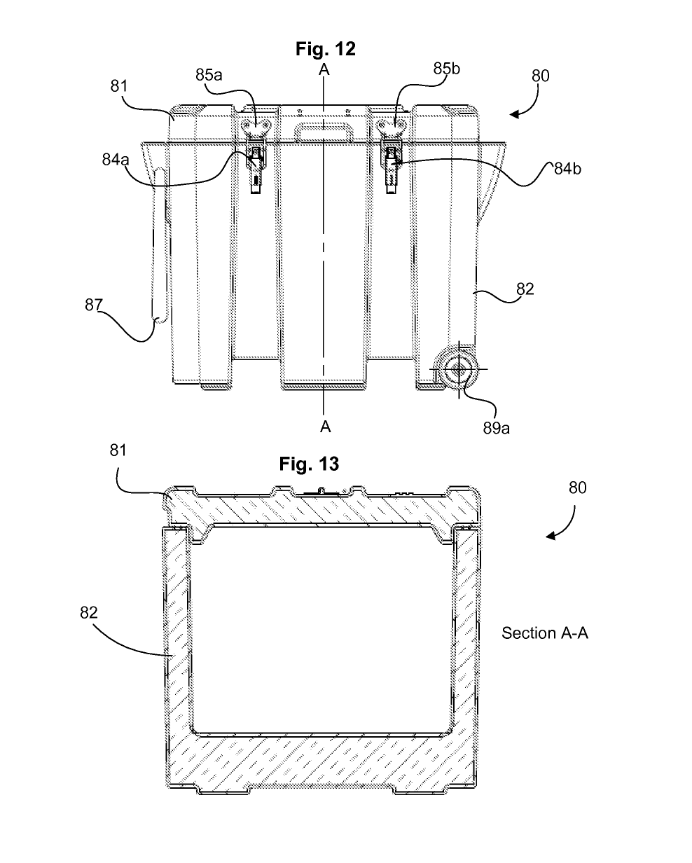

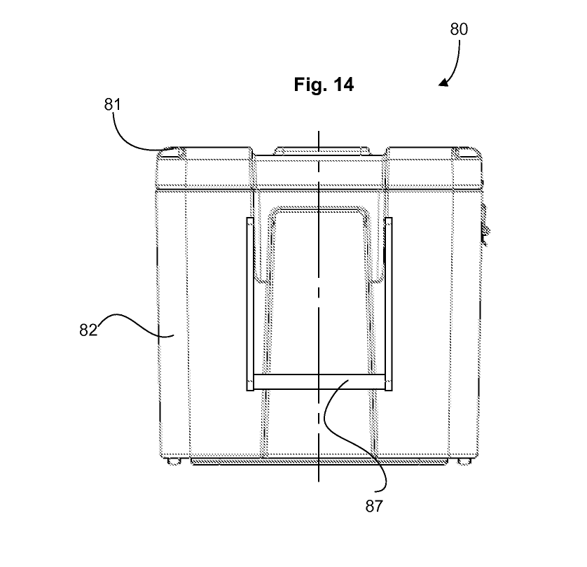

Referring to FIG. 8, this figure illustrates an exploded perspective view of a preferred embodiment of the transportation unit 80. The transportation unit 80 includes a lid section 81 and a base or body section 82 which join together to provide an air tight environment when the lid section 81 is engaged with the body section 82. As discussed for the inspection unit 10, the depth or height of the lid section 81 and the body or base section 82 can be varied, for example body section 82 could be substantially planar and lid section 81 could be provided with walls having substantial height. Also similarly as for the inspection unit 10, the transportation unit 80 is preferably provided with hinges 83a and 83b that fixedly attach to the lid section 81 and the body section 82 allowing the lid section 81 to rotate and close against the body section 82. Latches 84a and 84b are provided attached to the body section 82 and fix against hooks or protrusions 85a and 85b (see FIG. 12) attached to or integrated with the lid section 81. Also as discussed previously, the type, configuration, or combination of clamps, latches, hinges, etc. can be altered or varied as desired.

Also illustrated in FIG. 8 is a handle 86 fixed to the lid section 81. A further handle 87 can be provided to attach to protrusions 88a and/or 88b which assist a user with lifting or carrying the transportation unit 80. Furthermore, the transportation unit 80 can be provided with wheels 89a and 89b, fixed by a rod or axel 90 to the body section 82, that may assist with transportation of the transportation unit 80. Seals or gaskets 91 and 92 can also be provided associated with the lid section 81 and the body section 82, respectively, to assist in providing an air tight environment when the lid section 81 is engaged with the body section 82. Various indicia 93 can be provided on the transportation unit 80 indicating its contents may present a chemical or biological hazard.

It should be appreciated that a variety of mechanisms to seal lid section 81 against body section 82 can be envisaged. For example, hinge and latch means may not be provided but the lid section 81 may be adapted to press-seal against the body section 82. Any mechanical structure that allows the lid section 81 to affix, engage, secure, lock or the like with the body section 82, and provide a sealed environment, can be utilised in the present invention.

The transportation unit 80 is preferably made of a resilient plastic so that it can withstand external forces and/or shocks. Furthermore, the transportation unit 80 may be provided with internal padding and/or shock absorbing material. This assists in insulating the inspection unit 10 from damage or breach during transportation of the potentially dangerous object to the analysis site. Furthermore, the transportation unit 80 could be provided with locking means to prevent unauthorised access to the potentially dangerous object. In a particular form, the transportation unit 80 is fitted with two independent airtight seals and is double walled and insulated. In combination with the inspection unit 10 the apparatus thus provides a triple walled containment system with three independent airtight seals.

The following further example provides a more detailed outline of an embodiment of the present invention. The example is intended to be merely illustrative and not limiting to the scope of the present invention.

The apparatus for the contained inspection and transportation of suspect objects provides a light-weight, airtight and durable unit for the examination and transportation of mail suspected to contain a hazardous substance, for example a powder substance. The apparatus is preferably made of moulded plastic consisting of a tub-like lid which is provided with side entry portals for a user's hands to slip into built-in gloves. The base of the apparatus is preferably dark (black or dark blue) to provide the best contrast against a light coloured powdered substance. A moulded base section is fitted with an airtight seal and is further secured to the lid by locking clamps which should be able to survive dropping or other impacts intact. The lid section is transparent and is optionally provided with an in-built magnifying section allowing magnified examination of suspect mail.

Implements can be left within the apparatus for use by the user when inspecting mail. For example, a round-end flat blade letter opener could be provided. The total weight of the apparatus is preferably able to be easily handled without risk of the integrity of the sealed environment being breeched. A transportation unit of the apparatus receives the inspection unit and thus provides double-wall security during transport in the event of dropping or an accident occurring. Safety instructions and a preferred procedure to follow in the event of the receipt of suspicious mail can be provided to complement the apparatus.

The inspection unit is designed to allow the safe examination of mail, including larger envelopes, for example A4 size and small parcels, in a wholly contained environment. Once mail is identified as being suspicious and is believed to contain a hazardous material, for example a powder substance, the mail is placed into the inspection unit and the lid section is closed and locked. The suspicious mail is then opened or further inspected in the inspection unit with the user provided with a clear view through the lid section. If the mail contains any contaminant the inspection unit is then wholly placed within the transportation unit and transported to a suitable examination laboratory or analysis site by the appropriate personnel. This process also reduces the number of persons handling the suspicious mail thereby allowing preservation of possible forensic evidence.

Components of the apparatus are preferably single pieces of moulded plastic, the glove members could be vinyl gloves or made from any other suitable material. The transportation unit would preferably be clearly marked as containing bio-hazardous material. Seals used in the apparatus could be soft rubber seals. Padding or restraining devices can be provided internally to the transportation unit to assist in providing physical protection and/or stability for the inspection unit.

The inner inspection/containment unit can be designed to handle various sizes of suspicious mail, for example A4 size envelopes. Units of other dimensions can also be provided. In a particular preferred form the gloves are nitrile gloves, which have high chemical and abrasive resistance and do not expose the user to the risk of a latex reaction. In the preferred embodiment, the inspection unit weighs approximately three kilograms and is generally robust.

The outer transportation unit is built to high standards and is designed to cradle the inner inspection unit during transportation and to provide maximum protection of the inner inspection unit and its contents. The transportation unit may be of high visibility yellow colour and clearly marked as containing a potentially biological or chemical hazard. In this embodiment, the transportation unit is designed to withstand falls from up to three metres without damage to the contents, and the combined weight of the two units is approximately thirteen kilograms.

Thus, there has been provided in accordance with the present invention, apparatus for the contained inspection and, if required, transportation of potentially dangerous objects.

The invention may also be said to broadly consist in the parts, elements and features referred to or indicated herein, individually or collectively, in any or all combinations of two or more of the parts, elements or features, and where specific integers are mentioned herein which have known equivalents in the art to which the invention relates, such known equivalents are deemed to be incorporated herein as if individually set forth.

Although the preferred embodiment has been described in detail, it should be understood that various changes, substitutions, and alterations can be made herein by one of ordinary skill in the art without departing from the scope of the present invention.

What is claimed is:

1. Apparatus for the contained inspection and transportation of a suspicious object, the apparatus comprising:
an inspection unit, the inspection unit including a lid section and a base section, the inspection unit able to open to receive the object and then close to provide a sealed airtight environment for manual inspection of the object, the lid section and the base section being rigid, the lid section including supporting walls comprising side walls, a rear wall, a front wall, and a transparent top surface, formed integrally with the walls, extending between the walls so as to be positioned above the base section, the front wall including at least one glove member and the transparent top surface being downwardly sloped toward the front wall, the inspection unit further including a seal disposed below the at least one glove member and between the supporting walls and the base section when the inspection unit is closed so as to provide the sealed airtight environment; and
a transportation unit, the transportation unit including at least a first section and a second section able to open to wholly receive the inspection unit and then close to provide a further sealed airtight environment containing the inspection unit, the first section and the second section of the transportation unit being rigid.

2. The apparatus of claim 1 wherein at least one of the side walls, the rear wall, and the front wall is transparent.

3. The apparatus of claim 1 wherein at least a portion of the base section of the inspection unit is opaque, preferably of a dark color.

4. The apparatus of claim 1 wherein the object is an envelope, mail, package, parcel, letter, or the like.

5. The apparatus of claim 1 wherein the lid section and the base section of the inspection unit are adapted to be clamped or latched together.

6. The apparatus of claim 5 wherein the lid section and the base section of the inspection unit are hinged together.

7. The apparatus of claim 1 wherein the transportation unit can generally be lifted and moved by a single person.

8. The apparatus of claim 1 wherein the user can visually inspect the object in the inspection unit.

9. The apparatus of claim 1 wherein two glove members are provided.

10. The apparatus of claim 1 wherein the first section and the second section of the transportation unit are adapted to be clamped together.

11. The apparatus of claim 10 wherein the first section and the second section of the transportation unit each including corresponding faces which when in contact provide two independent airtight seals between the external environment and the further sealed airtight environment containing the inspection unit.

12. The apparatus of claim 10 wherein the first section of the transportation unit is a lid section and the second section of the transportation unit is a body section or a base section.

13. The apparatus of claim 12 wherein the lid section and the body section or base section of the transportation unit are adapted to be press-sealed together.

14. The apparatus of claim 1 wherein the inspection unit also includes integrated magnifying means in the lid section.

15. The apparatus of claim 1 wherein the transportation unit includes internal padding or shock absorbing material.

16. The apparatus of claim 1 wherein closure of the transportation unit securely holds the inspection unit placed therein.

17. The apparatus of claim 1 wherein the inspection unit is provided with a sealable port to receive a probe.

18. The apparatus of claim 17 wherein the inspection unit is provided with a further sealable inspection port having a diameter substantially larger than the sealable port.

19. Device for the contained inspection and safe transportation for further examination of received suspicious mail, the device comprising:
a rigid inspection unit that is able to open to receive the suspicious mail and then close to provide a sealed airtight environment, the inspection unit including a lid section and a base section which are adapted to provide the sealed airtight environment allowing a user to visually inspect the suspicious mail placed in the inspection unit, the lid section including supporting walls comprising side walls, a rear wall, a front wall, and a transparent top surface, formed integrally with the walls, extending between the walls so as to be located above the base section, the front wall including at least one glove member, and the transparent top surface being downwardly sloped toward the front wall, the inspection unit further including a seal disposed below the at least one glove member and between the supporting walls and the base section when the inspection unit is closed so as to provide the sealed airtight environment; and
a rigid transportation unit adapted to wholly receive and secure the inspection unit after user inspection of the mail and to provide a further sealed airtight environment and physical protection for the inspection unit during transportation.

20. The device of claim 19 wherein at least one of the side walls, the rear wall, and the front wall is transparent.

21. The apparatus of claim 1, wherein the front wall is transparent and an edge between the front wall and the transparent top surface is radiused.

22. The apparatus of claim 1, wherein each of side walls, the rear wall, and the front wall are transparent and edges between the side walls, the rear wall, the front wall, and the top surface are radiused.
